(19) United States
(12) Patent Application Publication
(10) Pub. No.: US 2024/0142412 A1
(43) Pub. Date: May 2, 2024

(54) APPARATUS AND METHOD FOR ULTRASONIC INSPECTION OF A MATERIAL

(71) Applicant: BWXT NOG Technologies, Inc., Lynchburg, VA (US)

(72) Inventors: Odey Grant Hariri, North Kingston, RI (US); Kristian Chase Johnson, Shipman, VA (US); Haivuong Josiah Phan, Springfield, VA (US)

(21) Appl. No.: 18/384,186

(22) Filed: Oct. 26, 2023

Related U.S. Application Data
(60) Provisional application No. 63/420,376, filed on Oct. 28, 2022.

(51) Int. Cl. G01N 29/24; G01N 29/04

(52) U.S. Cl. CPC G01N 29/2418; G01N 29/04; G01N 2291/023

(57) ABSTRACT

An ultrasonic transducer system has an ultrasonic transducer configured to emit ultrasonic energy in a direction and a plurality of light sources, each light source configured to emit a light beam that defines a beam pattern that intersects an axis of the emitted ultrasonic energy.

### RELATED APPLICATION

The present application claims the benefit of U.S. Provisional Patent Application No. 63/420,376, filed on Oct. 28, 2022, the entire disclosure of which is incorporated by reference herein.

### TECHNICAL FIELD

Example embodiments generally relate to material inspection and, in particular, non-destructive testing.

### BACKGROUND

A standard industry practice in measuring material thickness or detecting flaws in a material under test (which may be a device or a component part of a larger device) is to transmit ultrasonic energy into the material and measure the amplitude, time-of-flight, and other propagation characteristics of primary body waves that reflect back to the test device from a flaw within the material or from the side of the material opposite the side to which the ultrasonic energy is applied. An ultrasonic transducer (which, when assembled into a housing, is also referred to herein as an ultrasonic transducer probe) is disposed so that the transducer's ultrasonic transmitting surface faces the surface of the material under test across a gap of a predetermined or desired distance. That distance is filled by a coupling material, e.g., water, capable of transmitting the ultrasonic energy therethrough at an acceptable attenuation level. It is known to submerge the material under test and the ultrasonic transducer in water held in a suitably large container so that the test process is conducted while the transducer is wholly submerged and the material under test is partly or wholly submerged, but so that the transducer transmitting surface, the surface area of the material under test that is being examined, and the gap between the transducer transmitting surface and that surface area are all submerged. The transducer may be held in position with respect to the surface of the material under test by an ultrasonic scanner system. In some ultrasonic scanners, the scanner system engages the surface of the material under test at wheels or skids that are part of the scanner system so that the scanner system holds the transducer so that the transducer's transmitting surface is disposed at a predetermined distance from the test material surface. While maintaining such engagement with the test material surface, the scanner system is then moved over the test material surface, e.g., by hand, with the transducer's transmitting surface being maintained at the predetermined distance from the test material surface. In other arrangements, the scanner system is secured in position independently of the material under test, while suspending the transducer so that the transducer's transmitting surface is offset from the surface of the material under test by a predetermined distance. The operator may manually adjust, or the scanner system may automatically adjust, the scanner's position (or the transducer's position within the scanner) with respect to the material under test and/or the position of the material under test with respect to the scanner, or the position of both with respect to each other. The scanner (and, therefore, the transducer's transmitting surface) may be moved over the surface of the material under test automatically by the scanner (though under the operator's control) or by the operator's manual control, e.g., the manual movement of the scanner system with respect to the material under test or movement of the material under test with respect to the scanner. Thus, in any such arrangements, the transducer's transmitting surface (which may be generally planar or curved) is aligned with respect to the material under test in a predetermined spatial orientation and at a predetermined distance from the material surface. Ultrasonic scanners for such purposes are understood and are, therefore, not discussed in further detail herein.

As should be understood, ultrasonic transducers may radiate ultrasonic energy that is unfocused or, on the other hand, that focuses to a focal point. Where ultrasonic transducers focus the ultrasonic energy to a focal point, there exists an axis that extends from the transducer's transmitting surface to the ultrasonic energy focal point that is central to the focusing ultrasonic energy. An unfocused ultrasonic beam, however, also defines a center axis extending from the transducer's transmitting surface, as should be understood. Where the transducer probe includes a single element ultrasonic transducer, the probe housing is typically cylindrical in shape, with the ultrasonic energy center axis extending from the transducer's transmitting surface to the test material surface along the cylindrical housing's cylinder axis. Where the single element transducer is a focusing transducer, the transmitting surface is concave, from the perspective of the test material surface, whereas a non-focusing transducer may have a transmitting surface that is generally planar. A phased array transducer probe, on the other hand, includes multiple transducer elements in a non-cylindrical, e.g., rectangular cross-section, probe housing with a flat transducer transmitting surface. As should be understood, the probe controls the transducer elements to thereby steer the collective resulting ultrasonic beam in a desired direction. As the ultrasonic energy has a center axis, that desired direction of the ultrasonic radiation may be considered to be along the center axis, which may be defined orthogonally to the plane of the flat transducer transmitting surface but that may also be defined at an oblique angle to that plane. Again, the ultrasonic energy from the phased array transducer probe may be focused or unfocused.

As should be understood, where the transducer probe emits a focused ultrasonic beam, the operator often attempts to dispose the transducer (via disposition of the scanner) so that the ultrasonic energy focal point lies at a depth beneath the surface of the material under test at which discontinuities or other reflectors of interest are expected to occur. The focal point is the maximum focus of the ultrasonic energy. Thus, such an arrangement provides the highest resolution and maximum reflected amplitude for small reflectors at the depth of the focal point. As should be understood, the water path (which is the distance along the ultrasonic beam axis between the transducer transmitting surface to the surface of the material under test) can be considered, accounting for refraction due to the coupling material, as: (focal length in the coupling material along the beam axis)−(desired focus depth in the material under test)*((velocity of ultrasonic energy in the material under test)/(velocity of ultrasonic energy in the coupling material)). Typically, transducer manufacturers provide the focal point distance with the device as a device parameter (among others). Thus, it is known to hold (e.g., via a scanner) the transducer so that the transducer transmitting surface is offset from the surface of the material under test by a distance that provides a desired focus for reflectors of interest in the material under test.

Having imparted ultrasonic energy to the test material, the transducer probe then receives ultrasonic signals reflected by flaws in the material, or by the opposing side of the material under test, and that travel from the surface of the material under test, through the coupling material, to the transducer transmitting surface. Electronics associated with the transducer detect that received energy and convert it to data signals that the transducer outputs to a computing device for analysis. The manner of acquiring the received energy, converting the received energy to data signals, and analyzing the data signals to detect and locate flaws in and measure the depth of the material under test (via amplitude and ultrasonic energy time-of-flight information provided in the received data signals) is well understood and is, therefore, not discussed further herein.

It will also be understood that, in use, the transducer probe is moved about, over the surface of the material under test (e.g., while secured by the scanner to thereby maintain the transducer transmitting surface at the desired distance from the surface of the material under test), while the transducer probe's position on the material under test is recorded. As should be understood, the scanner may have a one dimensional or multi-dimensional axis/axes of motion aligned with the surface of the material under test. The scanner's motion over the surface of the material under test drives one or more respective encoders attached to the scanner housing about the axis/axes. Where a scanner is positioned independently of the material under test (the scanner possibly securing and controlling the position of the test material with respect to the transducer), the scanner may include a control drive system having one or more screw drives that move the transducer probe with respect to the material under test and/or the material under test with respect to the transducer probe. The screw drives drive respective encoders, so that the encoder output data describes the relative movement between the transducer probe and the surface of the material under test. Thus, using either type of scanner, the association of scan data from the transducer with encoder data provides information establishing the position on the test material surface from some predetermined starting position on the test material surface at which the encoder data is considered to start. All later encoder data respectively associated with data from scans thereby identifies each scan's position on the test material surface with respect to that starting point.

The scanner provides the encoder data and the transducer output data to a remote computing device that collects the encoder data and associates the data with the transducer output generated at individual scans by the transducer probe over respective positions on the test material surface as the scanner moves over the test material surface and outputs the transducer output with the encoder output so that transducer output data is associated with the encoder data received as that transducer output data was acquired. A user has initialized the remote computing device to expect the transducer/encoder output data with an assumption that the transducer/encoder data stream begins when the scanner is positioned over the predetermined starting point on the surface of the material under test. Thus, the encoder data, as compared to that initialization assumption of position on the material surface, identifies the distance and direction from that initial position of a point on the surface of the material under test at which the transducer output data was acquired. If the scanner is one dimensional, the processor of the remote device understands the encoder data to describe linear movement away from (either positively or negatively, depending upon which of the two directions from the initial position the scanner travels) the initial position, whereas if the scanner is two dimensional, the encoder data includes express information on distance and direction in a two-dimensional context. Either way, the processor associates individual transducer output with corresponding respective positions on the surface of the material under test relative to the known starting point, thereby allowing the processor to accumulate and store in memory the transducer output data mapped to information identifying the position on the material under test at which the transducer data was acquired. Correspondingly, the remote computer's processor may present to the user (via a user interface presented on a display screen located at the remote computing device) a visual image of the surface of the material under test with information corresponding to the interpreted transducer output at the respective positions on the material under test at which the transducer output data was acquired.

### BRIEF SUMMARY OF SOME EXAMPLES

Some example embodiments may include an ultrasonic transducer system having an ultrasonic transducer configured to emit ultrasonic energy in a direction from a transmitting surface, the ultrasonic energy defining an axis extending from the transmitting surface. Each light source of a plurality of light sources is configured to emit a light beam that defines a beam pattern and is mounted with respect to the ultrasonic transducer so that the light source emits its light beam in the direction. The light sources of the plurality of light sources are oriented with respect to each other so that, when the ultrasonic transducer is disposed so that the ultrasonic transducer emits the ultrasonic energy to a material surface, the light sources project their beam patterns onto the material surface so that the beam patterns intersect the axis in a predetermined configuration.

The accompanying drawings, which are incorporated in and constitute a part of this specification, illustrate one or more embodiments of the present invention.

### BRIEF DESCRIPTION OF THE SEVERAL VIEWS OF THE DRAWING(S)

Having thus described one or more embodiments of a material inspection system in general terms, reference will now be made to the accompanying drawings, which are not necessarily drawn to scale, and wherein:

FIG. 1 is an exploded schematic view of an ultrasonic transducer system in accordance with an embodiment of the present disclosure;

FIG. 2 is a schematic plan view of the ultrasonic transducer system embodiment as in FIG. 1;

FIG. 3 is a schematic perspective view of the ultrasonic transducer system embodiment as in FIG. 1;

FIG. 4 is a schematic perspective view of a light source sleeve of an ultrasonic transducer system embodiment as in FIG. 1;

FIG. 5 is a schematic perspective view of a line laser light source of an ultrasonic transducer system embodiment as in FIG. 1;

FIG. 6 is a schematic perspective view of a bracket band of an ultrasonic transducer system embodiment as in FIG. 1;

FIG. 7 is a schematic perspective view of an ultrasonic transducer and housing of an ultrasonic transducer system embodiment as in FIG. 1;

FIG. 8 is an exploded schematic view of an ultrasonic transducer system in accordance with an embodiment of the present disclosure;

FIG. 9 is a schematic perspective view of the ultrasonic transducer system embodiment as in FIG. 8;

FIG. 10 is a schematic plan view of the ultrasonic transducer system embodiment as in FIG. 8;

FIG. 11 is a schematic top view of the ultrasonic transducer system embodiment as in FIG. 8;

FIG. 12 is a schematic plan view of the ultrasonic transducer system embodiment as in FIG. 8;

FIG. 13 is a schematic perspective view of a key for connecting a light source sleeve and a gear of the ultrasonic transducer system embodiment as in FIG. 8;

FIG. 14 is a schematic perspective view of a light source sleeve of the ultrasonic transducer system embodiment as in FIG. 8;

FIG. 15 is a schematic perspective view of a bracket center collar of the ultrasonic transducer system embodiment as in FIG. 8;

FIG. 16 is a schematic perspective view of a laser light source of an ultrasonic transducer system embodiment as in FIG. 8;

FIG. 17 is a schematic perspective view of a bracket gear of an ultrasonic transducer system embodiment as in FIG. 8;

FIG. 18 is a schematic perspective view of an outer movable bracket collar of an ultrasonic transducer system embodiment as in FIG. 8;

FIG. 19 is a schematic perspective view of an ultrasonic transducer system in accordance with an embodiment of the present disclosure;

FIG. 20 is a perspective view of an ultrasonic transducer system embodiment as in FIG. 19 operatively disposed above a test material surface;

FIG. 21 is a top view of a bracket of an ultrasonic transducer system embodiment as in FIG. 19;

FIG. 22 is a flow chart illustration of a method in accordance with an embodiment of the present disclosure; and

FIG. 23 is a schematic perspective view of an ultrasonic transducer system in accordance with an embodiment of the present invention.

Repeat use of reference characters in the present specification and drawings is intended to represent same or analogous features or elements of the invention.

### DETAILED DESCRIPTION

Some example embodiments now will be described more fully hereinafter with reference to the accompanying drawings, in which some, but not all, example embodiments are shown. Indeed, the examples described and pictured herein should not be construed as being limiting as to the scope, applicability or configuration of the present disclosure. It will be apparent to those skilled in the art that modifications and variations can be made in such example embodiments without departing from the scope or spirit thereof. For instance, features illustrated or described in one embodiment may be used in another embodiment to yield a still further embodiment. Thus, it is intended that the present invention covers such modifications and variations as come within the scope of the present disclosure, the appended claims and their equivalents. Like reference numerals refer to like elements throughout.

It should be understood that terms of orientation, e.g., “forward,” “rearward,” “upper,” “lower,” and similar terms as used herein are intended to refer to relative orientation of components of the devices described herein with respect to each other under an assumption of a consistent point of reference but do not require any specific orientation of the overall system. Thus, for example, the discussion herein may refer to radiation of energy in a “forward” or “downward” direction, or away from a “front” or “bottom” surface of an ultrasonic transducer, referring to a direction away from the transducer's transmitting surface. Such terms may be used in the present disclosure and claims and will be understood to refer to a relative orientation but not to an orientation of a claimed device with respect to an external frame of reference.

Further, the term “or,” as used in this application and the appended claims, is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an,” as used in this application and the appended claims, should generally be understood to mean “one or more” unless specified otherwise or clear from the context to be directed to a singular form. Throughout the specification and claims, the following terms take at least the meanings explicitly associated therein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment” or other similar phrase, as used herein, does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A.

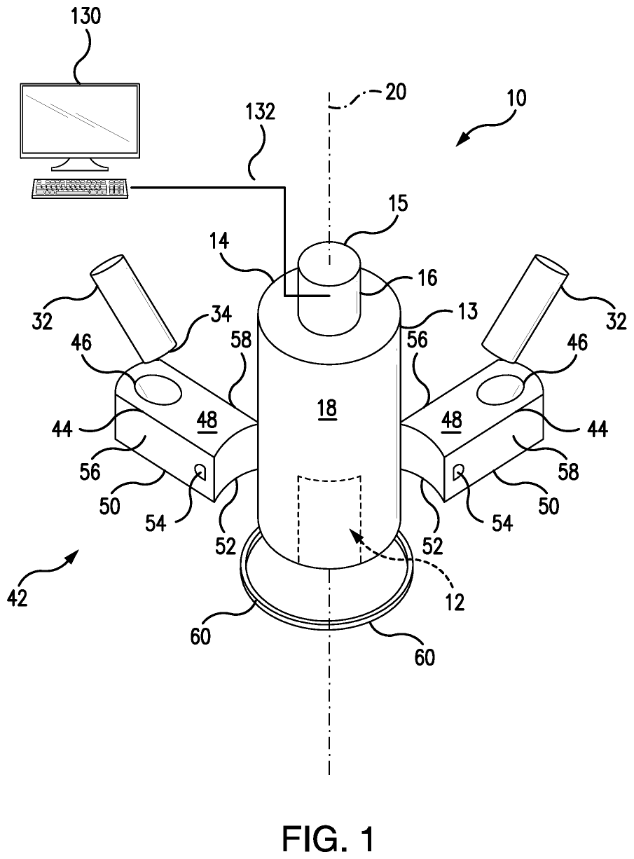

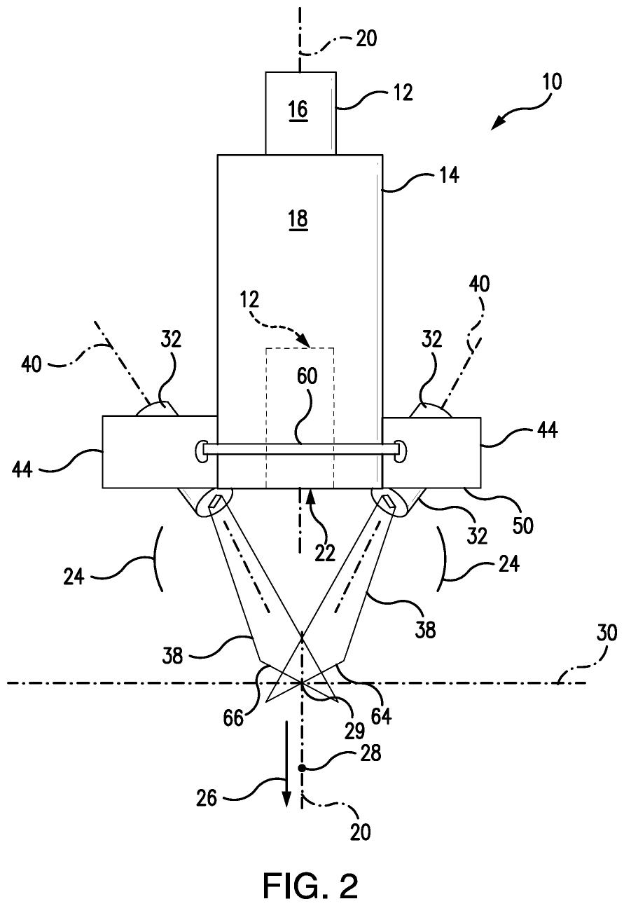

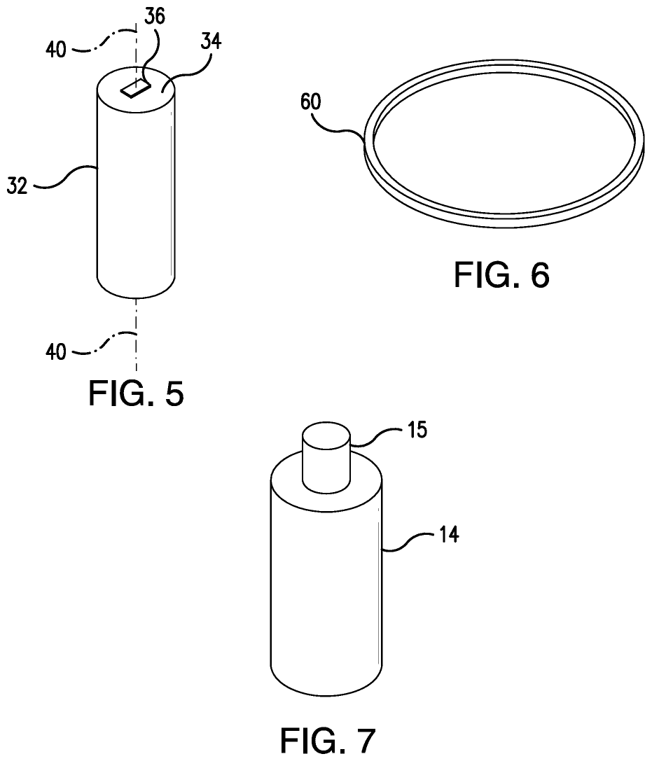

FIGS. 1-7 illustrate an example of an embodiment of an ultrasonic transducer system 10 according to the present disclosure. System 10 includes a single element transducer probe 14 including a piezoelectric transducer element (indicated schematically at 12) received and secured within a generally cylindrical housing 13 and a screw mount 15 for securing transducer probe 14 within a scanner. The generally cylindrical perimeters 16 and 18 of screw mount 15 and housing 13 are coaxial about an axis 20. A lower (in the orientation as in FIG. 2) transmitting surface 22 of transducer 14 emits ultrasonic energy downward, in the direction of arrow 26, in a beam having a beam pattern (indicated schematically by parentheses 24) centered on axis 20. A maximum beam diameter may be considered the maximum width of beam 24, orthogonal to axis 20, between points in the beam at which the power per unit area drops to 0.37 times its maximum value in the beam. In the illustrated embodiment, ultrasonic transducer 14 is a focusing transducer, with beam pattern 24 being generally symmetrical about axis 20 (such that axis 20 can be considered a center axis of beam pattern 24) and being focused by the transducer at a focal point through which axis 20 passes. It should be understood that the geometry of beam 24 may vary, that the distance along axis 20 between transmitting surface 22 and the focal point may vary, and that the strength and type of ultrasonic signal may vary. For instance, in some embodiments, ultrasonic transducer 14 may not be a focusing transducer, such that ultrasonic energy 24 is unfocused and does not focus to a focal point. Further, it should also be understood that the illustration of transducer probe 14 as having a generally cylindrical housing 13 for a single element 12 is provided for example only and that other transducer and transducer housing configurations, for example, a multi-element phased array transducer with a rectangular cross-sectioned transducer probe housing, fall within the scope of the present disclosure and may be used. The distance along axis 20 between the transducer's transmitting surface, e.g., at a point on the test material surface indicated at 28, and the test material surface is known as the “water path.”

The ultrasonic energy radiates in direction 26 to a test surface, indicated as a plane (extending into and out of the page) 30 in FIG. 2. As should be understood in view of the present disclosure, the transducer may be used at optimal performance, to detect discontinuities and other flaws beneath an area of the surface of the material under test at which axis 20 of ultrasonic beam 24 intersects the material test surface, by directing the ultrasonic energy to a point 28 on the test material surface that is above the expected position of such discontinuities or flaws in the test material along axis 20. If the transducer is a focusing transducer, the water path distance may be chosen so that the ultrasonic energy's focal point 29 coincides with a depth in the material under test below the surface thereof at point 28 and along axis 20 at which material flaws are expected to occur. In one or more embodiments, the single-axis transducer 14 is oriented, with respect to the plane 30, so that beam axis 20 is perpendicular to the material test surface plane or, where the material test surface is curved, its tangent plane, though in other embodiments, this intersection is at an oblique angle. The energy may reflect entirely or partially at the test material surface. Energy passing into the material may reflect back (including in a direction opposite direction 26) from discontinuities within the material and/or from the opposite side of the material. Where transducer 14 is part of a transceiver arrangement, transducer 14 receives the reflected energy and outputs the acquired signals by wired transmission to a remote computer for determining information from the received energy based on the amplitude, time-of-flight of the returned energy, and/or other propagation characteristics of reflected primary body waves. Such information may, for example, indicate the identity and depth of a flaw at an intermediate position within the material or the material's thickness based on reflection from the opposing material side.

It will be understood, however, in view of the present disclosure, that such and other embodiments discussed herein are presented for purposes of explanation and not in limitation of the present disclosure. For example, transducer 14 may be a single element transducer or a multiple element transducer arrangement. Ultrasonic beam 24 may be focused or unfocused. The housing of a single element transducer may be secured within the scanner so that a fixed beam axis is, in operation, orthogonal or at an oblique angle to the plane of the surface of the material under test or its tangent. In a multiple-element phased array transducer arrangement, the axis may be angularly defined in a desired position with respect to such a plane through control of the phased array. The transducer probe housing may be cylindrical or of a different cross-sectional shape. Thus, the present disclosure should be understood to encompass such, and other, variations.

Positioned about housing perimeter 18 are a plurality (in this example, two) light sources 32, which, in this example, are line lasers. As will be understood, each laser generates a beam of coherent, collimated light. At a transmitting end 34 of each laser 32, however, the laser includes an optical lens 36 that spreads the laser beam in one dimension, but not in the orthogonal dimension, thereby resulting in a generally planar beam pattern 38 that defines a (straight, or linear) line at its intersection with a plane, such as plane 30. Since plane 30 is, in the illustrated example, orthogonal to transducer ultrasonic radiation axis 20, the lines defined by the intersection of generally planar beam patterns 38 with plane 30 are also orthogonal to axis 20. Although plane 30 extends into and out of the page of FIG. 2, lines 64 and 66, which represent the intersection of beam patterns 38 with plane 30, are shown tilted from that perspective for purposes of illustration. It should be understood that the lines exist within plane 30, extending into and out of the page. Each light beam pattern 38 defines a center axis 40. In one or more embodiments, each light source beam pattern center axis 40 intersects ultrasonic beam axis 20, e.g. at an oblique angle, but, in other embodiments, the axes do not intersect.

A bracket 42 disposed about and engaging perimeter 18 of ultrasonic transducer housing 13 includes respective sleeves 44 that receive light sources 32 in cylindrical bores 46 that extend entirely through the respective sleeves 44 from a top surface 48 to a bottom surface 50 thereof. As is apparent in the figures, bores 46 are cylindrical in cross sectional shape because of the cylindrical perimeter of light sources 32, but it should be understood that the bores can be of different shapes to conform with differently-shaped light sources. Bores 46 are formed so that each secures its light source so that the center axis 40 of each light source's beam pattern is disposed at the same oblique angle with respect to vertical, though the present disclosure also encompasses embodiments in which the sleeves secure the light sources at such angles that differ among two or more light sources. In the embodiment illustrated in FIGS. 1-7, because bores 46 are cylindrical, the center longitudinal axis of each bore 46 is disposed at the same oblique angle with respect to vertical.

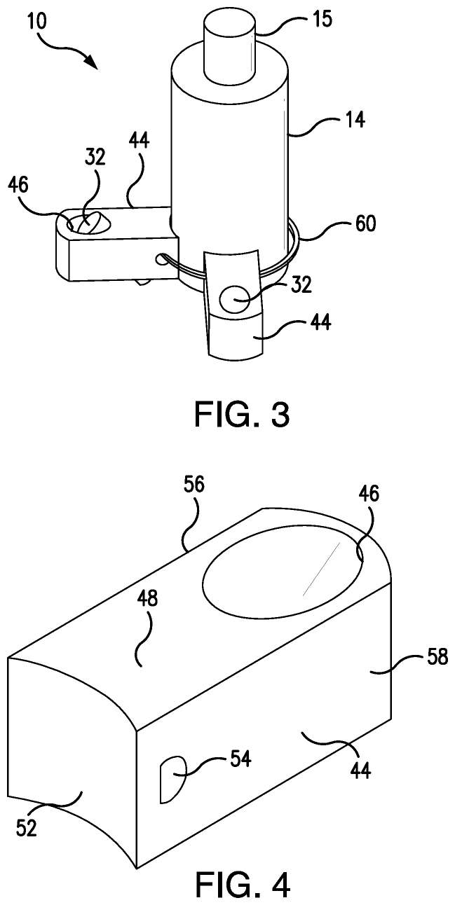

Each sleeve 44 has a forward surface 52 that, in cross-section of planes perpendicular to axis 20, defines a circular arc of the same radius that defines the circular circumference of perimeter 18 of transducer probe housing 13, so that surfaces 52 of bracket 42 conform to the surface of perimeter 18. The forward end of each sleeve also defines a bore 54 therethrough from one side 56 to an opposing side 58 of the sleeve. In one or more embodiments, the center of each bore defines a circular arc of a radius centered at the same point as the radius of the arc defined by the sleeve's corresponding surface 52, though it should be understood that, in other embodiments, the arcs of through-bores 54 and surfaces 52 are not concentric and that through-bores 54 are not necessarily arcuate. Bracket 42 also includes a circular elastic band 60 that, when unstressed, has an inner diameter that is smaller than the inner diameter of the inner surfaces of through-bores 54 when sleeves 44 abut perimeter 18 of housing 13 with their front surfaces 52. Thus, with band 60 extending through through-bores 54, as illustrated in the figures, it is necessary to pull sleeves 44 radially outward against band 60, thereby stretching band 60, to move sleeves 44 onto perimeter 18 of the transducer probe housing at sleeve surfaces 52. The resulting radially inward force applied by band 60 to sleeves 44 causes the sleeves to frictionally engage perimeter 18 of the transducer probe housing at sleeve forward surfaces 52, thereby securing sleeves 44 in position on the housing perimeter, both in circumferential direction about perimeter 18 and in the vertical (in the view of FIG. 2) direction, parallel to axis 20. Band 60 may also be non-elastic and non-continuous but provided with an over-center or other tightening clasp between the two ends of the band so that, when the band extends through through-holes 54 of sleeves 44 and the sleeves are placed against the transducer housing at their front surfaces 52, the operator may tighten the band to frictionally hold the sleeves in position on the housing. Because band 60 is slidably received through sleeve bores 54, such arrangements permit the angular positions of sleeves 44 (about a vertical axis, such as axis 20) with respect to each other to be selected as desired prior to or, depending on the frictional engagement between perimeter 18 and surfaces 52, after putting the sleeves onto perimeter 18, for example to accommodate spatial limitations at a given test site. As will be apparent from the present discussion, the angular orientation between the sleeves can vary. Thus, while FIG. 3 illustrates a 90° angular spacing, it will be understood that this is for example purposes only and that any other angular spacing could be used, barring interference of the sleeves with the testing environment or each other.

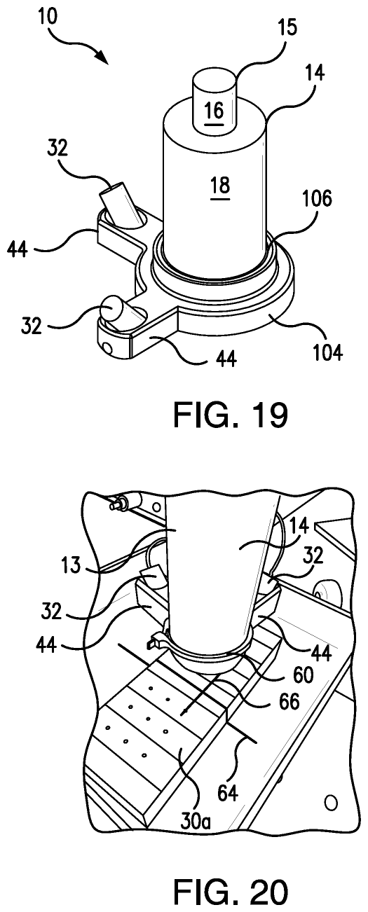

Light sources 32 may be retained in sleeve bores 46 through friction fit or other mechanism, e.g., by a respective set screw extending through the body of each sleeve (e.g., through a hole 39 in the sleeve for that purpose as shown in FIG. 19) and engaging the perimeter of the light source or being received in a corresponding slot in the light source perimeter so that the light source is secured in a predetermined position within its slot 46, both with respect to the back-and-forth directions of the axis of its slot 46 and angularly in the slot about its axis 40. In one or more embodiments, each line laser light source 32 is positioned in its corresponding sleeve bore 46 (whether fixed in such position by a mechanism such as a set screw or placed in such position at the light source's insertion into the bore in a friction fit) so that the projection of the laser's generally planar beam 38 into plane 30 is a line perpendicular to axis 20 (whether or not intersecting axis 20). Thus, when the sleeves are disposed on housing perimeter 18 so that their bottom surfaces 50 are parallel with transducer emitting surface 22, or otherwise low enough on transducer housing 13 so that the transducer housing does not block all or, in one or more embodiments, any portion of line laser 32 beam patterns 38, beam patterns 38 intersect plane 30 in respective (non-curved) lines that intersect each other at a point, provided the angular separation between sleeves 44 about axis 20 is not 0° or 180°. In the example arrangement of FIGS. 2 and 3, the two sleeves 44 are angularly offset from each other about axis 20 by 90°. Such an arrangement is illustrated in FIG. 20, in which two sleeves 44 are held by a tightenable non-continuous band 60 at the bottom of perimeter 18 of transducer housing 13 at a 90° offset from each other. The transducer housing is disposed directly above a generally planar material test surface 30a. Thus, the lines reflected by the lasers' beam patterns by a planar test surface at plane 30 or at test material surface 30a are orthogonal to each other.

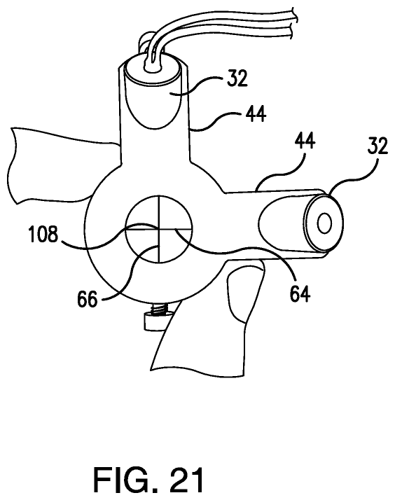

In one or more embodiments, each of light sources 32 is rotated about its axis 40, and secured within its sleeve bore 46 in that orientation, so that the plane of its generally planar laser light patterns 38 includes ultrasonic energy axis 20. Thus, each line 64 or 66 (from the two lasers 32 illustrated in the embodiments of FIGS. 1-7 and 20) projected in plane 30 or on test material surface 30a always crosses the other line 64 or 66 at axis 20, regardless of the water path's distance between the transducer's emitting surface 22 and the test material surface. This arrangement is illustrated in FIG. 21, which shows an example bracket 42 of an embodiment as in FIG. 19, discussed below, without the transducer and its housing. Bracket 42 has a continuous collar 104 that is formed unitarily with sleeves 44 and that defines a center bore 106 (that ordinarily receives the transducer housing). Sleeves 44 retain respective line lasers 32 in their through-bores 46, as discussed above, so that the planes of the line lasers' generally planar light beams each includes the transducer center axis, which corresponds to the center axis (extending into and out of the page in FIG. 21) of collar bore 106. Laser lines 64 and 66 reflect at test material surface 30a, and, as can be seen in FIG. 21, the intersection 108 of lines 64 and 66 is concentric with the circle of the cross section of center bore 106 and, therefore, with axis 20 (FIG. 2). Because the planes of the laser light sources' generally planar beams include axis 20, intersection point 108 remains on axis 20 if an operator (gripping collar 104 or a scanner holding collar 104 or the transducer housing) moves the collar toward or away from (along axis 20) test material surface 30a. Thus, in one or more such embodiments, bores 46 are disposed in sleeves 44, and laser light sources 32 are positioned in bores 46, and the angular offset between the sleeves about axis 20 is other than 0° and 180°, so that, when the sleeves are disposed at a predetermined position (axially, with respect to axis 20) on perimeter 18 of the transducer probe housing, e.g., as shown in FIG. 2, lines 64 and 66 in plane 30 intersect each other at a point that coincides with axis 20 regardless of the height of transmitting surface 22 above the test material surface (at plane 30, in FIG. 2) along axis 20. While FIG. 2 illustrates ultrasonic beam center axis 20 as orthogonal to plane 30 (which may represent the test material surface), the inclusion of axis 20 within planar beam patterns 38 also keep the resulting laser line crossing point on axis when axis 20 intersects plane 30 at an oblique angle.

In one or more other embodiments, light sources 32 are oriented about their axes 40, and secured within their sleeve bores 46 in that orientation, so that the planes of their generally planar laser patterns 38 intersect, but do not include, axis 20. In such embodiments, the point at which the lines (in plane 30) cross each other will vary with the height of transducer probe 14 above the test surface at plane 30. With reference to FIG. 2, for example, if transducer probe 14 (and, therefore, laser light sources 32) is moved upward along axis 20, the line 66 of the beam pattern of the left-positioned laser light source 32 will move to the right and out of the page, while the line 64 of the beam pattern of the right-positioned laser light source 32 will move to the left and out of the page. If, on the other hand, transducer probe 14 is moved closer to the test surface at plane 30 along axis 20, line 66 of the left-positioned laser light source 32 will move to the left and into the page, while the line 64 of the beam pattern of the right-positioned laser light source 32 will move to the right and into the page. In one or more embodiments, bores 46 are disposed in sleeves 44, and laser light sources 32 are positioned in sleeves 46, and the angular offset between the sleeves about axis 20 is other than 0° and 180°, so that, when the sleeves are disposed at a predetermined position (axially, with respect to axis 20) on perimeter 18 of transducer probe 14, e.g., as shown in FIG. 2, lines 64 and 66 in plane 30 intersect each other at a point 28 that coincides with axis 20 when transmitting surface 22 is at a predetermined water path height above the test material surface (at plane 30, in FIG. 2) along axis 20. As discussed above, the transducer probe may be disposed in an ultrasonic scanner so that the water path is at a fixed desired distance or so that the relative positions of the transducer and the test material with respect to each other is adjusted to achieve the desired water path distance. Thus, the orientations of the light sources can be so configured that the crossing point 28 of lines 64 and 66 coincide with axis 20 only at that desired water path distance along axis 20 from transmitting surface 22. Because deviation of point 28 from axis 20 may be visually detectable by the user, such an arrangement allows for a visual confirmation that the transducer is at the proper height above the test material surface in the system's operation or as the scanner's height above the test material surface is adjusted.

Thus, where transducer probe 14 is secured in a scanner that holds transducer housing 13 so that the transducer transmitting surface is directed toward the test material surface (so that the ultrasonic radiation is directed toward and to the test material surface), so that axis 20 intersects the test material surface (see, e.g., plane 30) at an orthogonal or oblique angle, and so that the transducer transmitting surface is offset from the test material surface along axis 20 approximately at the desired water path distance that produces the desired focus of ultrasonic energy in the test material, the two laser lines 64 and 66 cross, at point 28, on the test material surface at axis 20, in one or more embodiments. In a given embodiment, there will be tolerances for acceptable deviation between an exact coincidence between point 28 and axis 20 in plane 30, e.g., up to approximately 5 mm in some embodiments, and such deviations are understood to nonetheless be within coincidence of point 28 with axis 20. In other embodiments, as noted, bracket 42 secures the line lasers so that lines 64 and 66 cross at a point coincident with axis 20 regardless of the water path distance. In either type of embodiment, i.e., whether the line intersection point is coincident with the beam axis 20 only at a single distance from the transducer transmitting surface along axis 20 (e.g., corresponding to the desired water path distance) or is coincident with beam axis 20 regardless of the water path distance, the line lasers are secured in the bracket on the transducer probe housing so that the point at which the lines cross on the test material surface during a scan indicates the point on the test material surface at which the maximum ultrasonic energy (and, depending on the ultrasonic beam pattern, the center of that beam pattern) is applied at that particular water path distance.

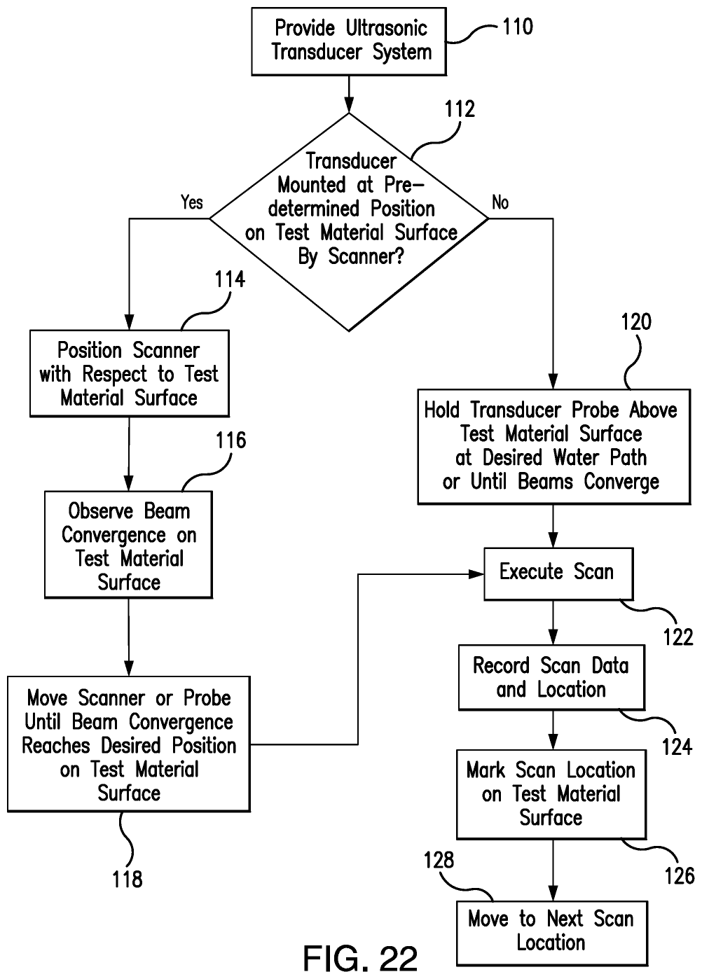

Particularly where the transducer/transducer housing and scanner arrangement is such that the operator cannot view the test material surface through the center of that arrangement (i.e., along axis 20), the line laser crossing allows the operator, who may be viewing the test material surface from the side of the scanner system rather than along its scanner axis 20, to rely on the light source beams to confirm that the scanner is correctly positioned to direct the transducer ultrasonic energy optimally to a desired position on the test material surface. With reference also to FIG. 22, a method according to the present disclosure includes the step 110 of providing an ultrasonic transducer system of an embodiment described herein or otherwise within the scope of the present disclosure. The providing step may encompass manufacture and/or assembly of the system but may also simply correspond to its possession for use. While one or more of the present examples assumes an embodiment as discussed with regard to FIGS. 1-7, it will be understood that other embodiments within the scope of the present disclosure may be provided at 110.

If, at 112, the transducer, its housing, and bracket 42 are held by a scanner configured to align transducer beam center axis 20 orthogonally or at an oblique angle to a planar test material surface (see plane 30) or a tangent plane of a curved test material surface so that transducer transmitting surface 22 faces the test material surface at a predetermined water path distance, the operator places the scanner onto the test material surface, at 114, so that the transducer's transmitting surface faces the test material surface and actuates the lasers. Where the scanner is positioned independently of the test material surface, the operator controls the scanner to position the transducer with respect to the test material surface, at 114, so that the transducer's transmitting surface faces the test material surface and actuates the lasers. The test material may be submerged prior to placing the scanner onto or in position with respect to the test material. If so, then step 114 encompasses placing the transducer system into the water or other coupling medium. If not, the test material and transducer assembly may be submerged at this point or at any time prior to the scan. If the scanner engages the test material surface so that the transducer is held at a fixed distance therefrom, the light source beam patterns are not needed to establish the water path. Where the scanner and/or the test material surface positions are adjusted with respect to each other by operation of the scanner or otherwise, the crossed lines may be used to locate the desired water path distance, as discussed herein. In either arrangement, the light source beam patterns can assist, given the water path distance defined by the scanner, in the operator's visual identification of the point on the surface of the test material at which the transducer's ultrasonic energy is optimally provided and for which the scan data will carry the most information. In that regard, in an embodiment in which the planes of the light sources' generally planar beams include axis 20, such that the laser lines always cross at axis 20, or in an embodiment in which those planes do not include axis 20 but in which the light sources are oriented so that the generally planar beam patterns 38 cross at axis 20 at the water path distance, the operator views the location of the lines' crossing point on the test material surface, at 116. If the intersection point is not at a position on the test material surface at which the operator wishes to make a scan, the operator, at 118, moves the scanner (automatically or manually) over the test material surface, or moves the scanner's or the test material's position with respect to the other, until the laser lines' intersection point reaches such a position on the material surface, thereby assuring the optimal application of ultrasonic energy to that desired point. The use of the laser lines also reduces error that might otherwise be caused by refraction as the operator views the test material through water, where the test material surface and the transducer housing are submerged in water or other coupling medium, since the refraction applies the operator's view of both the laser lines and the material surface.

If the transducer's location with respect to the test material surface is the transducer's initial positioning within a scan project to include a subsequent series of scans that are to be mapped with respect to each other, the operator may position the transducer (via positioning the scanner or controlling the transducer's position within the scanner) so that the laser lines' intersection point coincides with a predetermined feature of the test material surface, such as an edge corner, or a position on the test material surface that the operator marks in some manner. The operator initializes the scanner's encoder(s) or encoder data, so that the position on the test material surface of each subsequent scan in this measurement sequence/project is identifiable (with respect to this starting position) by the encoder data associated with the scan data acquired for each individual scan, as discussed herein. When step 118 is an initial positioning of the transducer at a point over the test material surface at which no scan is made, the process flow moves directly to step 128, rather than to step 122. As the operator operates the scanner to move the transducer's position above the test material surface to the position for the first scan, the scanner's screw drive(s) drive the scanner's encoder(s) so that the encoders' values when the transducer reaches the first scan position on the test material surface indicate the transducer's position on the test material surface relative to that initial point.

If, at 112, the transducer assembly is manually held, the operator may hold the transducer housing by hand in position over the test material surface. The operator may actuate the lasers at this point in the procedure, or earlier, e.g., by actuating a power supply that drives the lasers through a wired connection between the power source and the lasers. In an embodiment in which the planes of the lasers' generally planar beam patterns do not include axis 20, such that the laser lines cross axis 20 at only one water path distance, the assembly may be configured, and is configured in one or more embodiments, so that that distance corresponds to a predetermined water path distance along axis 20 from the transducer's transmitting surface to the test material surface at point 28. Where the line lasers have the same optical lenses that spread the laser beams into the line patterns, and where the lasers are held with their axes 40 at the same angle with respect to axis 20, the lines reflected at the test material surface (see plane 30) will have the same length, and will cross each other at the lines' center points and on axis 20, when the transducer housing is held so that axis 20 is substantially perpendicular to, or at a desired oblique angle with respect to, the test surface or a plane tangent to the test surface and when the transducer transmitting surface is at the desired predetermined height above the test material surface. Thus, by manually moving the transducer housing, at 120, over a desired point on the test material surface, and moving the transducer housing up and/or down (along axis 20) until visually confirming when those conditions occur over the desired point on the test material surface, the operator may thereby correctly position the transducer housing so that it delivers the optimal degree of ultrasonic energy to that point on the material surface and returns the optimal amount of information about that desired point in the scan data.

In other embodiments, light sources 32 do not include the spreading optical lenses of the line lasers that spread the laser light linearly and, instead, include collimating optical lenses 36 (FIG. 16) so that the lasers emit collimated beams and so that the beams intersect the test material surface (see plane 30) at respective points (or, slightly elongated points, depending on the angle of the laser's axis 40 with respect to vertical). In such embodiments, the lasers are disposed in bracket 42 so that their beams converge at point 28 on axis 20 at a desired water path distance. Thus, e.g., where the transducer probe is secured in a scanner positioned independently of the test material surface, the operator may adjust the relative position between the scanner and the test material surface, while viewing the reflections of the laser beams on the test material surface, until the laser beam dot reflections on the test material surface are coincident with each other on a point (28) on the test material surface. Where the operator holds the transducer by hand, the operator manually moves the transducer housing's position at 120 until visually confirming when the laser beam dot reflections on the test material surface are coincident with each other on a point on the test material surface. In such embodiments, the operator at this point may determine that the transducer housing is at the position over that surface point at which the transducer is delivering the optimal (or otherwise desired level of) ultrasonic energy from the transducer's ultrasonic energy pattern to that point on the test material surface. In a still further embodiment, in which the lasers output generally planar beams and the planes of the lasers' generally planar beams include axis 20, so that the resulting reflection lines' intersection is always on axis 20 regardless of the water path distance, the operator may locate the transducer housing over the desired position on the test material surface by locating that position with the crossed lines and then estimate the desired water path distance visually or by measurement using an additional measurement tool.

Again, and as should be understood in view of the present disclosure, the operator may, using the crossed laser lines or converging dots, locate the transducer housing/scanner in position above the test material surface for an ultrasonic scan prior to submerging the test material surface and transducer housing in water. Where the operator knows the location of the desired test point on the material surface, the operator moves the scanner and its transducer (or, just the transducer probe, if handheld) over that portion of the test material surface, and may adjust the relative positions of the scanner and the test material surface with respect to each other, until the intersection of the laser lines is located over the desired point. Where the test material surface is already submerged, the operator may perform the same steps with the already-submerged device and material, placing the transducer housing/scanner in the water and again relying on the laser lines to locate the transducer's proper position relative to the desired point on the material surface based on the laser lines' intersection or laser dot coincidence at the desired point on the test material surface.

From steps 118 or 120, the operator actuates the transducer at 122, thereby initiating a scan. The transducer emits ultrasonic radiation, receives reflected ultrasonic signals, and acquires and outputs data corresponding to the received ultrasonic signals to a remote computer 130 (FIG. 1) over wired connection 132 between computer 130 and transducer 14. Where the transducer is secured by and operated in a scanner, the computer also receives the scanner's encoder data associated with the scan position, as discussed above. The operator may review the results of the scan data on the display of computer 130 and may record the scan data (and information identifying the location on the test material surface at which it was obtained) in a file saved at computer 130 or otherwise, at 124. Where encoders are used to relate scan point positions, as discussed above, the encoder position data may be associated with the scan measurement data in the file. If the computer display indicates a defect in the material at the point from which the scan data was acquired, the operator may rely on the crossed laser lines to identify the point on the test material surface at which the operator, at 126, makes a mark (e.g., by an ink marker or by scoring the material surface with a hardened device) on the material test surface. Depending on the method and mechanism used to make the mark, the operator may make the mark either when the material and the transducer housing are submerged or, instead, after the water is drained. The operator may then move the transducer housing/scanner to the next scan location, at 128, thereby returning the process flow to step 112. Each time the operator moves a transducer operated in a scanner, the scanner's encoder(s) increment, so that each acquired scan data, being associated with the encoders' information (as it exists at the time of the scan), is locatable with respect to the scan project starting position on the test material surface. When the operator executes the last scan step, the scan project ends, rather than proceeding to step 128. Once the scan is complete, the operator may return to the marked positions on the test material surface for further analysis, which may include removing a portion of the test material at the marked points.

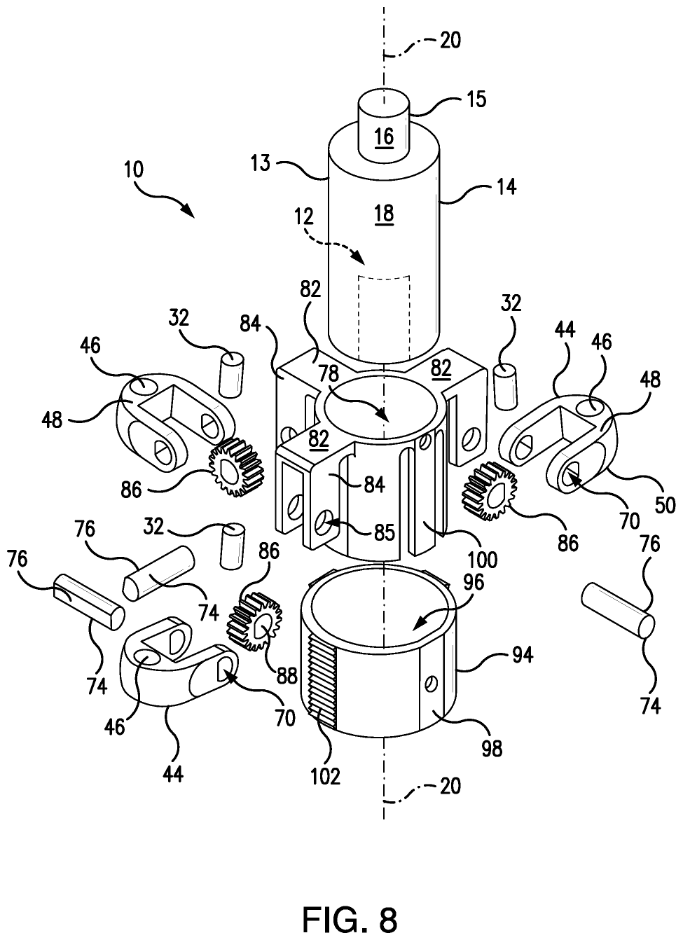

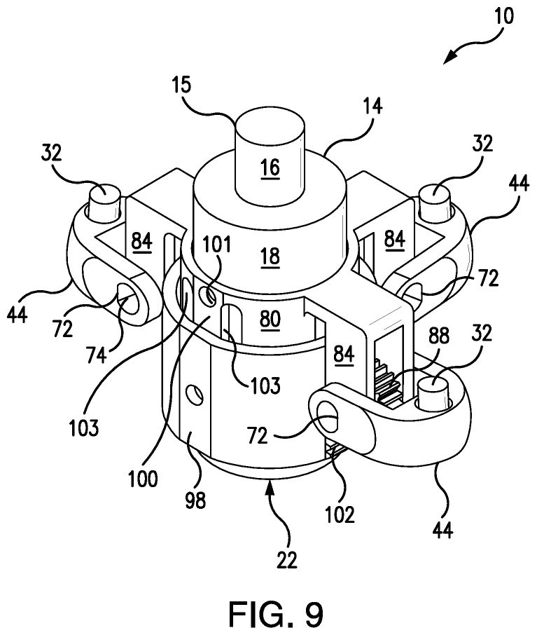

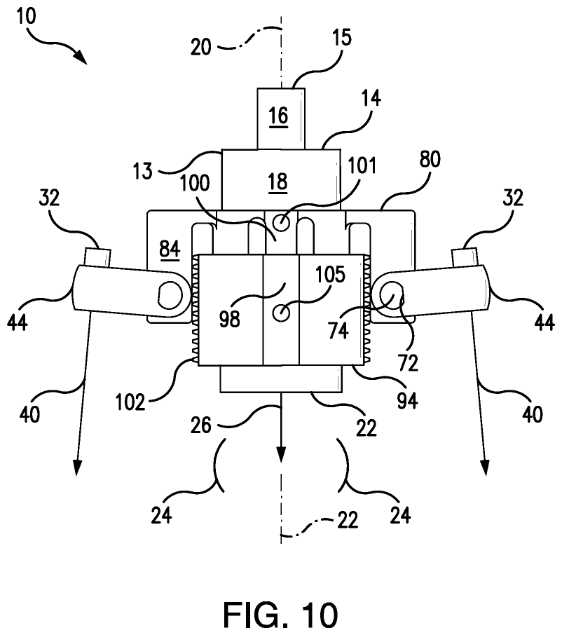

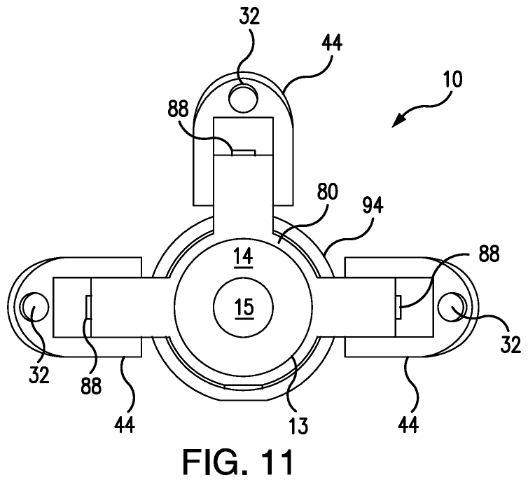

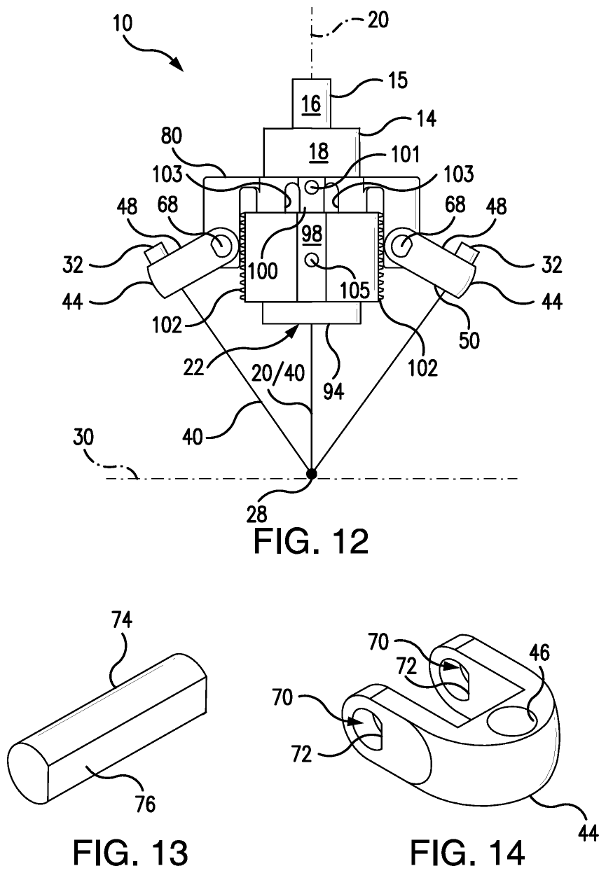

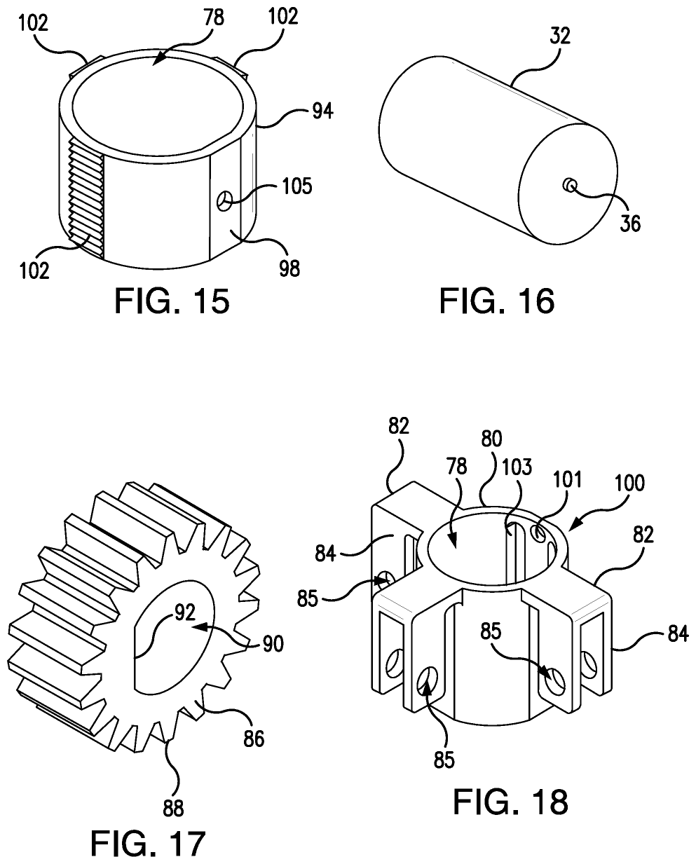

FIGS. 8-18 illustrate an example of a further embodiment of an ultrasonic transducer system 10 according to the present disclosure. System 10 includes a single element ultrasonic transducer 14, for example as discussed above with respect to the embodiments of FIGS. 1-7, having a housing 13 configured so that the generally cylindrical perimeters 16 and 18 of screw mount 15 and the generally cylindrical housing 13 are coaxial about axis 20. A lower (in the orientation as in FIG. 10) transmitting surface 22 of transducer 14 emits ultrasonic energy downward, in the direction of arrow 26, in a beam having a beam pattern 24 being generally symmetrical about axis 20 (such that axis 20 can be considered a center axis of beam pattern 24), being focused or unfocused, and being directed by the transducer at a point 28 (FIG. 12) on the test material surface through which axis 20 passes. As noted above, it should be understood that the geometry of beam 24 may vary, that the desired distance along axis 20 between transmitting surface 22 and point 28 (or the water path, generally) may vary, and that the strength and type of ultrasonic signal may vary.

The ultrasonic energy radiates in direction 26 to a test surface, indicated as a plane (extending into and out of the page) 30 in FIG. 12, as described above with regard to the embodiments of FIGS. 1-7. The variations discussed with regard to the earlier embodiments apply with regard to the embodiments of FIGS. 8-18. Where transducer 14 is part of a transceiver arrangement, transducer 14 receives ultrasonic energy reflected from the top surface, discontinuities within, and/or the opposing side of the test material, and outputs the acquired signals by wired transmission to a remote computer for determining information from the received energy based on amplitude, time-of-flight of the returned energy, and/or other propagation characteristics of reflected primary body waves.

Positioned about housing perimeter 18 are a plurality (in this example, three) light sources 32, which, in this example, are lasers that output collimated beams along respective axes 40. As discussed below, the angular position of each of axes 40 relative to axis 20 is adjustable. In one or more embodiments, it would be possible to rotate sleeves 44 so that axes 40 are all perpendicular to axis 20, so that laser beams from light sources 32 do not radiate, even in part, parallel to axis 20. But in such embodiments, the light sources are also positionable in operation so that a component of the direction of radiation of the beams from light sources 32 is parallel to axis 20 and toward the test material surface. Thus, the radiation is described herein as radiating in direction 26. As indicated in FIG. 12, sleeves 44 may be angularly positioned about their axes 68 so that the laser beam axes 40 (the axis 40 of the laser directly behind the transducer housing in the view of FIG. 12 is directly behind axis 20 in the view of FIG. 12; thus, the line that appears as axis 20 in FIG. 12 is also labeled as 40) converge together, and coincident with axis 20, at point 28 at plane 30. As discussed above with respect to the embodiments of FIGS. 1-7, point 28 is not necessarily the ultrasonic energy focal point, which is often desired to be located at a point of depth in the test material, but it can be. As also discussed above with respect to the embodiments of FIGS. 1-7, laser light sources 32 are secured in bores 46 by friction fit or other means, such as respective set screws extending through the body of the sleeves 44 to engage the cylindrical sides, or a corresponding slot in the sides, of the laser light sources.

A bracket 42 disposed about and engaging perimeter 18 of the housing of ultrasonic transducer probe 14 includes respective sleeves 44 that receive light sources 32 in cylindrical bores 46 that extend entirely through the respective sleeves 44 from a top surface 48 to a bottom surface 50 thereof. As noted with regard to the embodiments of FIGS. 1-7, the cross-sectional shape of bores 46 may vary, e.g., depending on the circumferential shape of the surfaces of light sources 32. Cylindrical bores 46 extend through their sleeves 44 so that the center axes of the bores (and, therefore, the center axes of the beams from the light sources) extend perpendicularly to the sleeves' pivot axes 68. Each sleeve 44 is in the form of a yoke with two side arms extending toward the transducer housing. At each sleeve, at the ends of the side arms, a bore 70 extends therethrough. Bore 70 defines a flat side 72. Received in each bore 70 is a respective lock pin 74 having an outer perimeter shaped correspondingly to bore 70, so that the lock pin 74 defines a flat side 76. Each lock pin 74 is sized so that it is received in its corresponding bore 70 in a friction fit. Thus, lock pin 74 is receivable in its bore 70 only if pin flat side 76 opposes the flat side 72 of bore 70, thereby rotationally locking lock pin 74 within its bore 70 with respect the bore's axis 68.

The housing of ultrasonic transducer probe 14 is received by, and secured by press fit within, a central cylindrical bore 78 of an inner collar 80 of bracket 42. Other mechanisms, such as a set screw (received, e.g., through a threaded through-bore 101 extending through inner collar 80 to allow the set screw to engage the transducer probe housing) or keyed interface, may retain the transducer housing within bore 78 so that inner collar 80 and transducer probe 14 do not move with respect to each other in operation. Extending radially outward from the generally cylindrical center portion of inner collar 80 are three sub-brackets 82. Each sub-bracket 82 has a top portion that attaches to and extends directly out from the cylindrical center portion of inner collar 80 and a pair of downwardly depending flanges 84. The opposing flanges 84 of each sub-bracket 82 are received between the yoke side arms of the corresponding sleeve 44, with bore 70 being aligned with a bore 85 that extends completely through the two side arms. Bore 85 is generally cylindrical, and slightly larger than the perimeter of the pin 74 that passes through it, in cross-section (perpendicular to axis 68) and without a flat section, so that lock pin 74 is received through bore 85 rotatably about axis 68.

Disposed at the center of each lock pin 74 is a respective pinion gear 86 having a set of radially extending gear teeth 88 disposed about the generally cylindrical circumference thereof and a through bore 90 extending through the center thereof. Through bore 90 is sized just larger than the cross-sectional circumference of lock pin 74 and has a flat surface 92. The cross-sectional dimensions of through bore 90 are just enough larger than the cross-sectional circumferential surface of lock pin 74 that the lock pin can only be received in through bore 90 when flat surface 76 opposes flat surface 92, so that pinion gear 86 is rotationally locked to lock pin 74 about axis 68. Accordingly, sleeve 44 and its light source 32 pivot with its pinion gear 86 as the pinion gear rotates about axis 68.

A generally cylindrical outer collar 94 has a generally cylindrical central bore 96 extending entirely therethrough and centered on axis 20. The cross-sectional (perpendicular to axis 20) dimensions of central bore 96 are slightly larger than the cross-sectional outer dimensions of the generally cylindrical center portion of inner collar 80, so that the generally cylindrical center portion of inner collar 80 is slidably received within central bore 96 of outer collar 94. A flat section 98 is defined in the generally cylindrical wall of outer collar 94, so that the wall has flat surfaces on the outer collar's exterior and interior surfaces. The generally cylindrical center portion of inner collar 80 defines a corresponding flat surface 100. The cross-sectional dimensions of central bore 96 are just enough larger than the cross-sectional circumferential surface of the generally cylindrical center portion of inner collar 80 that the center portion of inner collar 80 can only be received in through-bore 96 when flat surface 100 opposes the flat portion of the wall of outer collar 94, so that outer collar 94 is rotationally locked to inner collar 80 about axis 20. Additionally, the inner circumferential surface of outer collar 94 may define two flanges (not shown) that extend radially inward so that respective flanges are received within axially directed slots 103, thereby additionally rotationally securing the outer collar to the inner collar.

The perimeter surface of outer collar 94 defines three rows of teeth 102, with each row extending parallel to axis 20 (with the teeth being perpendicular to the dimension of axis 20). The three rows are spaced apart so that when outer collar 94 is slidably received over inner collar 80 in the angular position (about axis 20) defined by the mating between flat surface 100 and flat section 98 and by the outer collar flanges within slots 103, a respective row of teeth 102 opposes and engages teeth 88 of a respective pinion gear 86. The teeth of each row of teeth 102 are complementary to teeth 88 so that the teeth of the row of teeth 102 mesh with teeth 88. The row of teeth 102 is thereby a rack to its pinion gear 86, and as the operator manually grips outer collar 94 and moves the collar up and down (in the dimension of axis 20) with respect to inner collar 80, each set of moving rack teeth 102 drives rotation of its corresponding pinion gear 86 (and, through the pinion gear's engagement with lock pin 74, sleeve 44 and light source 32) about axis 68. Accordingly, in the view of FIGS. 10 and 12, the operator's movement of outer collar 94 upward with respect to inner collar 80 rotates the righthand sleeve 44 in the clockwise direction and the lefthand sleeve 44 in the counterclockwise direction. The operator's movement of outer collar 94 downward with respect to inner collar 80 rotates these sleeves 44 in the opposite directions. Viewed with respect to axis 20, the operator's movement of outer collar 94 upward moves light sources 32 downward, while the operator's movement of outer collar 94 downward moves light sources 32 upward. When the operator moves outer collar 94 to a desired position axially on inner collar 80, the operator threads a set screw (not show) into a threaded through-bore 105 extending through the wall of outer collar 94 until the set screw's forward end engages inner collar surface 100 to create a frictional engagement between the collars that secures the outer collar's axial position on the inner collar.

Assume, for example, that the operator manually grips outer collar 94 when the assembly is in the position shown in FIG. 10 and moves outer collar 94 upward. Sleeves 44 begin to rotate downward about axes 68 so that axes 40 (and the laser beams from lasers 32 about those axes) reach and pass through a position in which they are parallel to axis 20. Bracket 42 secures light sources 32 equidistantly from axis 20 and in corresponding positions in sleeves 44 and about axes 68. Thus, when one of the light sources (and its axis 40) is parallel to axis 20, all light sources (and their corresponding axes 40) are parallel to axis 20. And, when the beams pivot inward (toward axis 20) from that vertical position, all the beams converge at a common point on axis 20. As soon as the beams cross inward from vertical, that point of convergence is distant from transducer transmitting surface 22, but as the operator continues to move outer sleeve 94 upward, the convergence point correspondingly moves upward, but remains on axis 20, eventually reaching the point 28 at the desired water path distance. In one or more embodiments, bracket 42 includes a detent between the inner surface of outer collar 94 and the outer surface of the generally cylindrical center portion of inner collar 80 that engages when outer collar 94 reaches the position on inner collar 80 at which the laser beams converge on a predetermined desired point 28. For example, a spring biased ball may be provided in the inner wall of outer collar 94 so that the spring biases the ball inward toward axis 20 and the outer surface of the generally cylindrical center portion of inner collar 80, and a groove or other depression provided in the outer surface of the center portion of inner collar 80 so that the ball engages the depression when the laser beams converge on desired point 28. This provides a tactile response to the operator's hand when the outer sleeve reaches such position, thereby notifying the operator that the laser beams have converged at the desired point. Movement of the outer collar upward continues the laser beam convergence point's upward movement on axis 20, thereby allowing the operator to locate the beam coincidence at other points on axis 20 if desired. Particularly where there is no singularly desired water path distance, a detent may not be desired and, therefore, omitted.

In operation, the operator may initially position outer collar 94 so that the detent engages, thus indicating to the operator that the lasers converge at desired point 68 and retaining outer collar 94 in that position with respect to inner collar 80 absent force manually applied by the operator. The operator may then lock the outer and inner collars by actuating the set screw through the bore 105. The operator may then install the transducer probe assembly 10 into a scanner for operation as discussed above with regard to FIG. 22. In handheld operation, the operator holds the assembly over the test material surface so that the ultrasonic energy and the laser beams are directed to the test material surface. Due to the laser beams' convergence, the operator can immediately determine if the water path distance between the transducer transmitting surface and the test material surface is the desired distance by observing whether the dots reflecting from the laser beams' incidence on the test material surface are coincident. If they are, then operator knows that the transducer device is at the distance needed to apply the ultrasonic energy to the point on the material test surface at which the laser beam dots have converged. If the beam dots are not coincident, the operator moves the entire transducer probe assembly 10 up or down with respect to the test material surface along axis 20 until the dots converge, thereby indicating that the optimal distance has been reached. If, however, spatial restrictions are such that the operator cannot position the assembly at the optimal distance from the test material surface, the operator may move outer collar 94 up or down, as the case may be, until the dots converge. While the device will not be emitting the ultrasonic energy to the test material surface at the desired point, the operator will nonetheless know the point on the test material surface at which the energy is optimally directed, given the spatial restrictions. In either a scanner-held or handheld embodiment, the adjustability provided by the arrangement of outer and inner collars 80 and 94 allows the operator to select a desired water path distance applicable to the particular measurement for which the transducer assembly is to be used. The operator can then execute the scan and mark the scan's position on the test material surface, as described above.

FIG. 19 illustrates another embodiment of the present disclosure, in which sleeves 44 are fixedly secured to a unitary collar 104, rather than by band 60 (FIG. 1). Thus, the sleeves are not positionally adjustable about axis 20 as are the sleeves in the embodiments of FIGS. 1-7. In this example, the sleeves are fixed to collar 104 so that the angular offset between the (in this instance, two) light sources 32 is 90°. Collar 106 defines a generally cylindrical center bore extending entirely through collar 104 that receives the housing of ultrasonic transducer 14 in a press fit, so that the transducer's transmitting surface 22 (FIG. 2) is even with the bottom surfaces of sleeves 44, as in FIG. 2. The device operates as discussed above with regard to the embodiments of FIGS. 1-7.

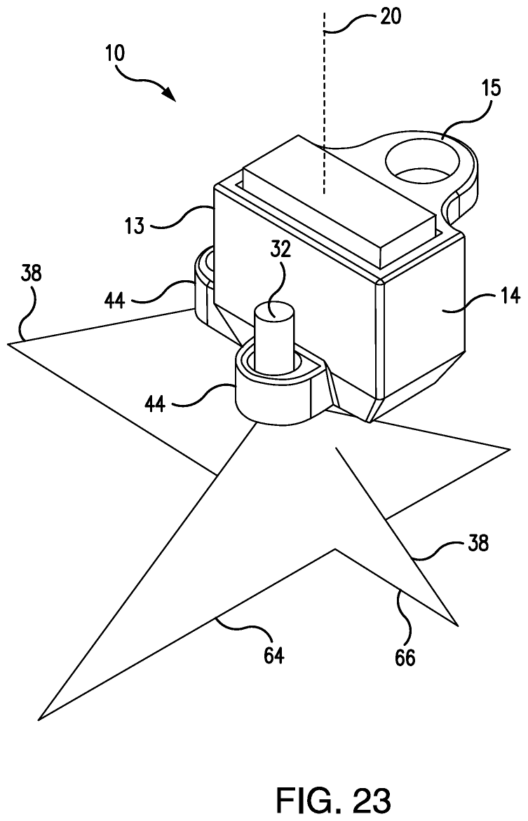

FIG. 23 illustrates a still further embodiment of the present disclosure, in which sleeves 44 are fixed directly to transducer housing 13 of multi-element phased array transducer probe 14. As illustrated, the transducer housing has a mount 15 and has a rectangular cross-section in a plane orthogonal to ultrasonic beam pattern center axis 20 (when the phased array controls the beam pattern to extend directly downward), so the disposition of sleeves 44 on adjoining sides of the housing disposes the two light sources 32 at a 90° angular offset with respect to each other about axis 20. The device operates as discussed above with regard to the embodiments of FIGS. 1-7, except with regard to the phased array transducer elements.

Many modifications and other embodiments of the inventions set forth herein will come to mind to one skilled in the art to which these inventions pertain having the benefit of the teachings presented in the foregoing descriptions and the associated drawings. Thus, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments but not necessary all example embodiments. Thus, any advantages, benefits, or solutions described herein should not be thought of as being critical, required, or essential to all embodiments or to that which is claimed herein. Although specific terms are employed herein, they may be used in a generic and descriptive sense only and not for purposes of limitation.

What is claimed is:

1. An ultrasonic transducer system, comprising:
an ultrasonic transducer configured to emit ultrasonic energy in a direction from a transmitting surface, the ultrasonic energy defining an axis extending from the transmitting surface; and
a plurality of light sources, each light source configured to emit a light beam that defines a beam pattern and mounted with respect to the ultrasonic transducer so that the light source emits its light beam in the direction,
wherein the light sources of the plurality of light sources are oriented with respect to each other so that, when the ultrasonic transducer is disposed so that the ultrasonic transducer emits the ultrasonic energy to a material surface, the light sources project their said beam patterns onto the material surface so that the beam patterns intersect the axis in a predetermined configuration.

2. The system as in claim 1, wherein each said beam pattern defines a center axis.

3. The system as in claim 2, wherein each center axis does not orthogonally intersect the axis extending from the transmitting surface.

4. The system as in claim 2, wherein each center axis is not parallel with the axis extending from the transmitting surface.

5. The system as in claim 3, wherein each center axis does not intersect the axis extending from the transmitting surface.

6. The system as in claim 1, further comprising a bracket mounted on the ultrasonic transducer and in which the light sources of the plurality of light sources are secured in respective orientations with respect to the ultrasonic transducer.

7. The system as in claim 6, wherein the bracket comprises a plurality of sleeves that are discrete from each other, each sleeve receiving at least one light source of the plurality of light sources in its said respective orientation.

8. The system as in claim 7, wherein the bracket comprises a band surrounding a perimeter of the ultrasonic transducer and passing through each sleeve of the plurality of sleeves so that the band holds the sleeves of the plurality of sleeves in position against the perimeter.

9. The system as in claim 1, wherein each light source of the plurality of light sources is a laser.

10. The system as in claim 1, wherein each light source of the plurality of light sources is a line laser.

11. The system as in claim 2, wherein each light source of the plurality of light sources is a laser.

12. The system as in claim 2, wherein each light source of the plurality of light sources is a line laser.

13. The system as in claim 11, wherein the beam pattern of a first said light source and the beam pattern of a second said light source intersect at a point on the axis extending from the transmitting surface at a predetermined distance from the transmitting surface.

14. The system as in claim 1, wherein the ultrasonic energy is focused on a focal point.

15. The system as in claim 13, wherein each of the light beam of the first said light source and the light beam of the second said light source is collimated.

16. The system as in claim 12, wherein the beam pattern of a first said light source is generally planar and intersects a plane normal to the axis extending from the transmitting surface in a line, wherein the beam pattern of a second said light source is generally planar and intersects the plane in a line, and wherein the line of the first said light source and the line of the second said light source intersect each other in the plane at a point on the axis extending from the transmitting surface at a predetermined distance from the transmitting surface.

17. The system as in claim 12, wherein the beam pattern of a first said light source is generally planar and intersects a plane normal to the axis extending from the transmitting surface in a line, wherein the beam pattern of a second said light source is generally planar and intersects the plane in a line, and wherein each of a plane of the generally planar beam pattern of the first light source and a plane of the generally planar beam pattern of the second light source includes the axis extending from the transmitting surface.

18. The system as in claim 6, wherein the bracket comprises
a collar that surrounds a perimeter of the ultrasonic transducer and is movable on the perimeter in a direction parallel to the axis extending from the transmitting surface,
a plurality of sleeves that are discrete from each other, each sleeve being attached to the ultrasonic transducer pivotally about an axis transverse to the axis extending from the transmitting surface and receiving at least one light source of the plurality of light sources,
wherein each said sleeve defines a gear that engages a rack defined on the collar so that movement of the collar in the direction parallel to the axis extending from the transmitting surface rotates each sleeve about its axis transverse to the axis extending from the transmitting surface to thereby move the light beam of the at least one source received by the sleeve.

19. A method of operating an ultrasonic transducer system, comprising the steps of:
providing an ultrasonic transducer configured to emit ultrasonic energy in a direction from a transmitting surface, the ultrasonic energy defining an axis extending from the transmitting surface;
mounting a plurality of light sources, each light source configured to emit a light beam that defines a beam pattern, with respect to the ultrasonic transducer so that the light source emits its light beam in the direction, wherein the light sources of the plurality of light sources are oriented with respect to each other so that, when the ultrasonic transducer is disposed so that the ultrasonic transducer emits the ultrasonic energy to a material surface, the light sources project their said beam patterns onto the material surface so that the beam patterns intersect the axis in a predetermined configuration; and
disposing the ultrasonic transducer with respect to the material surface so that the beam patterns intersect the axis in the predetermined configuration.

20. The method as in claim 19, wherein, at the mounting step, each said beam pattern defines a center axis.

21. The method as in claim 19, wherein, at the mounting step, each light source of the plurality of light sources is a laser.

22. The method as in claim 19, wherein, at the mounting step, each light source of the plurality of light sources is a line laser.

23. The method as in claim 20, wherein, at the mounting step, each light source of the plurality of light sources is a laser.

24. The method as in claim 20, wherein, at the mounting step, each light source of the plurality of light sources is a line laser.

25. The method as in claim 23, wherein, at the mounting step, the beam pattern of a first said light source and the beam pattern of a second said light source intersect at a point on the axis extending from the transmitting surface at a predetermined distance from the transmitting surface.

26. The method as in claim 19, including the step of focusing the ultrasonic energy on a focal point.

27. The method as in claim 24, wherein
at the mounting step, the beam pattern of a first said light source is generally planar and intersects a plane normal to the axis extending from the transmitting surface in a line,
at the mounting step, the beam pattern of a second said light source is generally planar and intersects the plane in a line,
at the mounting step, the line of the first said light source and the line of the second said light source intersect each other in the plane at a point on the axis extending from the transmitting surface at a predetermined distance from the transmitting surface, and
at the disposing step, the material surface coincides with the plane.

28. The method as in claim 24, wherein
at the mounting step, the beam pattern of a first said light source is generally planar and intersects a plane normal to the axis extending from the transmitting surface in a line,
at the mounting step, the beam pattern of a second said light source is generally planar and intersects the plane in a line,
at the mounting step, each of a plane of the generally planar beam pattern of the first light source and a plane of the generally planar beam pattern of the second light source includes the axis extending from the transmitting surface, and
at the disposing step, the material surface coincides with the plane normal to the axis extending from the transmitting surface.

29. The method as in claim 19, comprising the step of moving the plurality of light sources with respect to the ultrasonic transducer to select an intersection of the beam patterns with the axis in the predetermined configuration.

30. The method as in claim 29, wherein
the providing step comprises providing a bracket mounted on the ultrasonic transducer and in which the light sources of the plurality of light sources are secured in respective orientations with respect to the ultrasonic transducer, and
at the providing step, the bracket comprises
a collar that surrounds a perimeter of the ultrasonic transducer and is movable on the perimeter in a direction parallel to the axis extending from the transmitting surface,
a plurality of sleeves that are discrete from each other, each sleeve being attached to the ultrasonic transducer pivotally about an axis transverse to the axis extending from the transmitting surface and receiving at least one light source of the plurality of light sources,
wherein each said sleeve defines a gear that engages a rack defined on the collar so that movement of the collar in the direction parallel to the axis extending from the transmitting surface rotates each sleeve about its axis transvers to the axis extending from the transmitting surface to thereby move the light beam of the one or more light sources received by the sleeve.
